(19) United States
(12) Patent Application Publication
(10) Pub. No.: US 2026/0289284 A1
(43) Pub. Date: Sep. 24, 2026

(54) DATA PROCESSING METHOD FOR EXPERT MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Nemin QIU, Beijing (CN); Haoshuang WANG, Beijing (CN); Qingqing DANG, Beijing (CN); Yanlin SHA, Beijing (CN); Dianhai YU, Beijing (CN); Yanjun MA, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 19/687,490

(22) Filed: May 26, 2026

(30) Foreign Application Priority Data
Jun. 30, 2025 (CN) 202510897237.2

(51) Int. Cl. G06N 3/0495; G06N 3/0499

(52) U.S. Cl. CPC G06N 3/0495; G06N 3/0499

(57) ABSTRACT

Provided is a data processing method for an expert model, an electronic device and a storage medium, relating to the field of data processing technology, particularly in the fields of artificial intelligence, large models, and big data. The method includes: partitioning target feature data based on a total number M of GPUs used in distributed processing to obtain a feature block to be processed by each of the GPUs, where the target feature data is sub feature data in total feature data corresponding to a target task, M is an integer greater than 1; processing the feature block through at least two feed forward networks in a target expert module to obtain an initial processing result of the target feature data; and obtaining a target processing result for the target task based on the initial processing result of the target feature data.

### CROSS-REFERENCE TO RELATED APPLICATIONS

The present application claims priority to Chinese Patent Application No. CN202510897237.2, filed with the China National Intellectual Property Administration on Jun. 30, 2025, the disclosure of which is hereby incorporated herein by reference in its entirety.

### TECHNICAL FIELD

The present disclosure relates to the field of data processing technology, particularly in the fields of artificial intelligence, large models, big data and the like.

### BACKGROUND

An Expert Large Language Model (E-LLM, also known as an expert large model) has made significant breakthroughs in various fields and is increasingly becoming a mainstream architecture for large models. However, when faced with massive data, the E-LLM encounters bottlenecks in computation, resulting in low inference efficiency and reduced user experience.

### SUMMARY

The present disclosure provides data processing method and apparatus for an expert model, a device and a storage medium.

According to an aspect of the present disclosure, a data processing method for an expert model is provided, which includes:
partitioning target feature data based on a total number M of GPUs used in distributed processing to obtain a feature block to be processed by each of the GPUs, wherein the target feature data is sub feature data in total feature data corresponding to a target task, M is an integer greater than 1;
processing the feature block to be processed by each of the GPUs through at least two feed forward networks in a target expert module to obtain an initial processing result of the target feature data; and
obtaining a target processing result for the target task based on the initial processing result of the target feature data.

According to another aspect of the present disclosure, a data processing apparatus for an expert module is provided, which includes:
a processing unit configured to partition target feature data based on a total number M of GPUs used in distributed processing to obtain a feature block to be processed by each of the GPUs, process the feature block to be processed by each of the GPUs through at least two feed forward networks in a target expert module to obtain an initial processing result of the target feature data, and obtain a target processing result for a target task based on the initial processing result of the target feature data, wherein the target feature data is sub feature data in total feature data corresponding to the target task, M is an integer greater than 1; and
an outputting unit configured to output the target processing result for the target task.

According to another aspect of the present disclosure, an electronic device is provided, which includes:
at least one processor; and
a memory connected in communication with the at least one processor;
the memory stores an instruction executable by the at least one processor, and the instruction, when executed by the at least one processor, enables the at least one processor to execute the method of any embodiment in the present disclosure.

According to another aspect of the present disclosure, a non-transitory computer-readable storage medium storing a computer instruction thereon is provided, where the computer instruction is used to cause a computer to execute the method of any embodiment in the present disclosure.

According to another aspect of the present disclosure, a computer program product is provided, which includes a computer program, the computer program, when executed by a processor, implements the method of any embodiment in the present disclosure.

In this way, when using the target expert module to process the target feature data, the solution of the present disclosure can utilize the M GPUs to perform distributed processing on the target feature data and obtain the initial processing result, therefore, when facing task inference of large-scale data, it can significantly improve computational efficiency and inference efficiency of the model while ensuring inference effect of the model, thereby ensuring real-time inference of the target expert module and laying a foundation for improving user experience, at this point, it also provides strong support for improving inference efficiency of a hybrid expert large model (such as performing large-scale data inference) in the future.

It should be understood that contents described in this part is not intended to identify key or important features of embodiments of the present disclosure, nor is it intended to limit the scope of the present disclosure. Other features of the present disclosure are made easy to be understood by the following description.

### BRIEF DESCRIPTION OF THE DRAWINGS

Accompanying drawings are provided for a better understanding of the present scheme and do not constitute a limitation of the present disclosure, in which:

FIG. 1 is a first schematic flow diagram of a data processing method for an expert model according to an embodiment of the present disclosure;

FIG. 2 is a first schematic diagram a processing flow in an example of a target exert model in a data processing method for an expert model according to an embodiment of the present disclosure;

FIG. 3 is a second schematic diagram a processing flow in an example of a target exert model in a data processing method for an expert model according to an embodiment of the present disclosure;

FIG. 4 is a third schematic diagram a processing flow in an example of a target exert model in a data processing method for an expert model according to an embodiment of the present disclosure;

FIG. 5 is a fourth schematic diagram a processing flow in an example of a target exert model in a data processing method for an expert model according to an embodiment of the present disclosure;

FIG. 6 is a second schematic flow diagram of a data processing method for an expert model according to an embodiment of the present disclosure;

FIGS. 7(a) and 7(b) are schematic flow diagrams of a data processing method for an expert model according to another embodiment of the present disclosure;

FIG. 8 is a schematic diagram of a smoothing process on a first linear result corresponding to a GPU according to an embodiment of the present application;

FIG. 9 is a fifth schematic diagram a processing flow in an example of a target exert model in a data processing method for an expert model according to an embodiment of the present disclosure;

FIG. 10 is a third schematic flow diagram of a data processing method for an expert model according to an embodiment of the present disclosure;

FIG. 11 is a schematic diagram of respective target expert modules included in a hybrid expert large model according to an embodiment of the present disclosure;

FIG. 12 is an explanatory diagram of hierarchical division of feed forward networks in different target expert modules according to an embodiment of the present application;

FIG. 13 is a structural diagram of a data processing apparatus for an expert model according to an embodiment of the present disclosure; and

FIG. 14 is a block diagram of an electronic device for achieving a data processing method for an expert model according to an embodiment of the present disclosure.

### DETAILED DESCRIPTION

Hereinafter, explanation of exemplary embodiments of the present disclosure will made in conjunction with the accompanying drawings, which includes various details of the embodiments of the present disclosure to facilitate understanding and should be considered merely exemplary. Therefore, those having ordinary skill in the art should recognize that various changes and modifications may be made to the embodiments described herein without departing from the scope of the present disclosure. Similarly, for clarity and conciseness, descriptions of well-known functions and structures are omitted in the following descriptions.

The term “and/or” herein is merely an associated relationship for describing associated objects, which indicates that there may be three kinds of relationships, for example, A and/or B may mean that there are three cases: A alone, both A and B, and B alone. The term “at least one of . . . ” herein refers to any one of a plurality of items or any combination of at least two of the plurality of items, for example, including at least one of A, B or C may represent any one or more elements selected from a set consisting of A, B, and C. The terms “first” and “second” refer to a plurality of similar technical terms and distinguish them, and do not limit an order thereof or limit there are only two items, for example, a first feature and a second feature refer to two types/two features, the first feature may be one or more and the second feature may also be one or more.

In addition, in order to better illustrate the present disclosure, a number of specific details are given in specific implementations below. Those having skill in the art should understand that the present disclosure may also be implemented without certain specific details. In some examples, methods, means, elements and circuits which are well known to those having skill in the art are not described in detail, so as to highlight the main purpose of the present disclosure.

An Expert Large Language Model (E-LLM) has made significant breakthroughs in various fields and is increasingly becoming a mainstream structure for large language models. As a core of the E-LLM, an expert computing module (also known as an expert module) may process a corresponding token by specifying an expert in a field, thus have an ability of processing specific problems in the field. However, the processing of the expert computing module requires a significant amount of storage overhead and computational overhead, the storage overhead primarily involves a video memory occupied in a high-performance computing card (such as a GPU), and the computational overhead includes memory access overhead and kernel computation overhead during computation, these overheads hinder high-efficiency inference of the expert large language model and makes its deployment prohibitively expensive.

Based on this, the solution of the present disclosure provides a data processing method for an expert model, which can partition data to be processed through a target expert module, such as target feature data, and when the data is processed based on the target expert module, a plurality of GPUs can be called for distributed processing. In this way, when facing large-scale data, data processing efficiency of the target expert module is effectively improved, thereby improving inference efficiency of the model and laying a foundation for improving user experience. At this point, it also provides strong support for improving inference efficiency of a hybrid expert model (such as performing large-scale data inference) in the future.

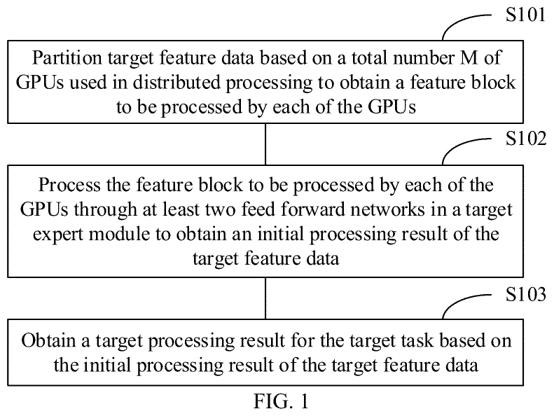

Specifically, FIG. 1 is a first schematic flow diagram of a data processing method for an expert model according to an embodiment of the present disclosure. This method may be optionally applied to an electronic device, such as a personal computer, a server, a server cluster, or other electronic devices.

Furthermore, the method at least includes at least a portion of the following contents. As shown in FIG. 1, the method includes following steps.

In step S101, target feature data is partitioned based on a total number M of GPUs used in distributed processing to obtain a feature block to be processed by each of the GPUs, M is an integer greater than 1.

Here, the target feature data is sub feature data in total feature data corresponding to a target task. In other words, the target feature data is sub data of the total feature data.

In step S102, the feature block to be processed by each of the GPUs is processed through at least two feed forward networks in a target expert module to obtain an initial processing result of the target feature data.

That is, the target feature data to be processed by the target expert module is split into a plurality of feature blocks, each feature block corresponds to one GPU, at this point, each feature block is processed on each GPU based on processing logic in the target expert module (such as the at least two Feed Forward Neural Networks (FFNs)), so as to obtain an output result corresponding to each GPU, and then obtain the initial processing result for the target feature data. In this way, compared to a manner of completing processing of the target expert module based on a single GPU, the solution of the present disclosure can utilize a plurality of GPUs for parallel processing, effectively improving data processing efficiency and also enhancing data processing efficiency of the target expert module.

Here, it should be noted that in one example, the target expert module may be specifically an expert model, an expert large model, or the like. The solution of the present disclosure does not impose specific limitations on a network structure of the target expert module.

In step S103, a target processing result for the target task is obtained based on the initial processing result of the target feature data.

In this way, when using the target expert module to process the target feature data, the solution of the present disclosure can utilize the M GPUs to perform distributed processing on the target feature data and obtain the initial processing result, therefore, when facing task inference of large-scale data, it can significantly improve computational efficiency and inference efficiency of the model while ensuring inference effect of the model, thereby ensuring real-time inference of the target expert module and laying a foundation for improving user experience, at this point, it also provides strong support for improving inference efficiency of a hybrid expert large model (such as performing large-scale data inference) in the future.

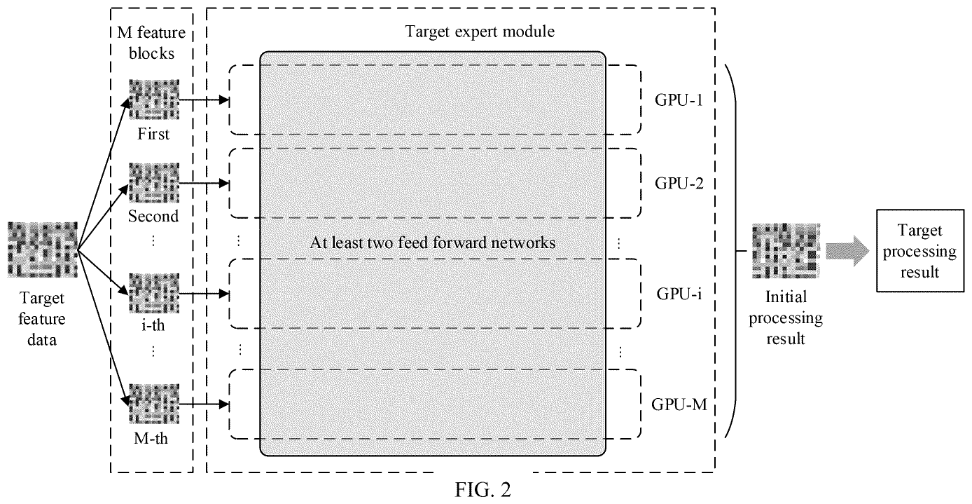

For example, as shown in FIG. 2, a number of the GPUs used by distributed processing is M, which may be respectively referred to as GPU-1, GPU-2, . . . , GPU-i, . . . , and GPU-M, at this point, the target feature data may be divided into M feature blocks based on the number M of the GPUs used in distributed processing, the M feature blocks may be respectively referred to as a first feature block, a second feature block, . . . , an i-th feature block, . . . , and an M-th feature block. When using the target expert module to process the target feature data, the M GPUs are called to perform parallel processing on the M feature blocks corresponding to the target feature data. For example, each GPU is used for processing a feature block, and a processing result of each GPU is obtained in a distributed manner, so as to finally obtain the initial processing result. In this way, when using the target expert module with a large number of parameters for data processing, calling the plurality of GPUs for distributed processing is beneficial for improving processing efficiency.

Furthermore, in order to further improve the inference efficiency of the target expert module, the solution of the present disclosure may further quantify the target expert module in two dimensions, such as activation quantification or weight quantification. It should be noted that in practical applications, quantifications in the following two dimensions may be used either separately or simultaneously, which may effectively improve the inference efficiency.

Specifically, the quantifications in the two dimensions will be explained in detail below.

### First Part, Activation Quantification

Specifically, at least a part of the following processing manners may be used to quantify activation values input to the feed forward networks in the target expert module.

In a specific example, before processing through the feed forward networks, activation quantization processing may be performed on feature blocks to be input to a target feed forward network of the at least two feed forward networks, and after the activation quantization processing is completed, the features blocks may be processed through the feed forward networks to obtain the initial processing result. That is, before using the target feed forward network to process the input M feature blocks, the activation quantization processing is firstly performed on the input M feature blocks, and then the target feed forward network is used to process the M feature blocks which have been subjected to the activation quantization processing, to obtain the initial processing result. In this way, by performing the activation quantization processing on the feature blocks, data bit widths of the feature blocks may be effectively reduced, thereby reducing dependence and occupation of a hardware resource (such as a storage space) by the model. At this point, it also improves the computational efficiency inside the model, laying a foundation for accelerating inference speed of the model and improving the user experience in the future.

For example, in a specific example, the activation quantization processing described in the solution of the present disclosure may be specifically INT8 quantization. Here, the INT8 quantization specifically refers to a technique of converting floating-point values (such as FP32) in a network model into 8-bit integers (INT8), thereby reducing model size, improving inference speed, and decreasing power consumption.

Furthermore, in a specific example, the at least two feed forward networks include a first feed forward network and a second feed forward network connected in series with the first feed forward network.

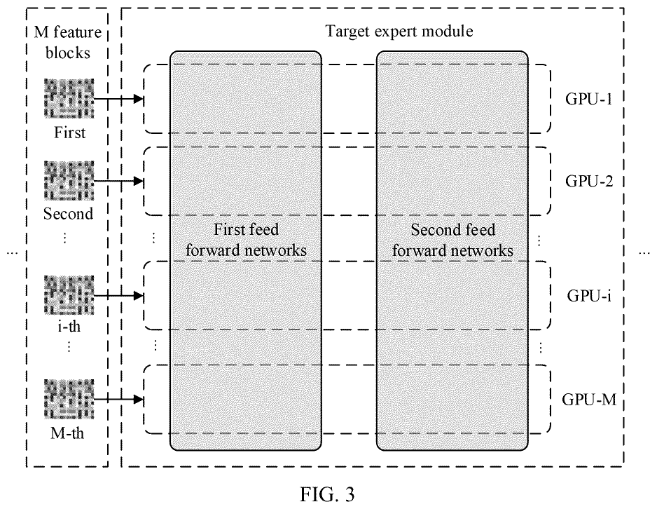

For example, continuing with the structure of the target expert module shown in FIG. 2 as an example, the at least two feed forward networks in the target expert module include the first feed forward network and the second feed forward network. At this point, as shown in FIG. 3, an output of the first feed forward network is an input of the second feed forward network, and an output of the second feed forward network is an input of a next network layer and the lie. Furthermore, when utilizing the first and second feed forward networks in the target expert module for processing, each of which may call the M GPUs for distributed processing. In other words, each feature block is processed on its corresponding GPU sequentially through the first and second feed forward networks in the target expert module.

In practical applications, the target expert module may further include other network layers, such as a fully connected layer, which is connected in series with the second feed forward network. At this point, the output of the second feed forward network may be used as an input of the fully connected layer, and an output of the fully connected layer is an input of a next network layer or a final input.

It should be noted that the solution of the present disclosure does not impose specific restrictions on other network layers included in the target expert module.

Furthermore, in an example, the target feed forward network is either the first feed forward network or the second feed forward network.

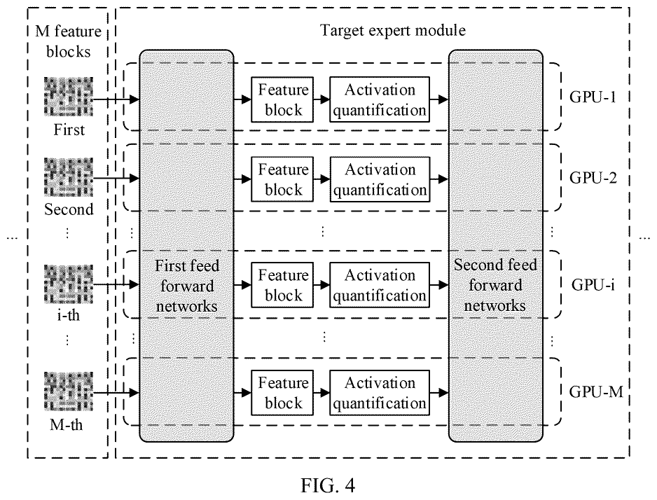

For example, in an example, continuing with the structure of the target expert module shown in FIG. 3 as an example, for the i-th GPU of the M GPUs used in distributed processing, as shown in FIG. 4, after obtaining a feature block output by the first feed forward network in the target expert module on the i-th GPU, and before processing the feature block output by the first feed forward network through the second feed forward network, the activation quantization processing is performed on the feature block output by the first feed forward network on the i-th GPU, and then the feature block which has been subjected to the activation quantization processing is processed through the second feed forward network, so as to improve the data processing efficiency.

Alternatively, in another example, before processing through the first feed forward network, the activation quantization processing is performed on the i-th feature block to be input to the first feed forward network, so that the first feed forward network processes the i-th feature block which is subjected to the activation quantization processing.

Alternatively, in yet another example, the solution of the present disclosure may perform the activation quantization processing on both feature blocks to be input to the first feed forward network and feature blocks to be input to the second feed forward network, in order to further improve the data processing efficiency.

In this way, the solution of the present disclosure provides a refined structure of the target expert module and a refined activation quantization solution, which improves the data processing efficiency while ensuring extraction of richer feature data using the refined target expert module. Moreover, the solution of the present disclosure can also use activation quantization processing to quantize high-bit (such as 16-bit or 32-bit) activation values into low-bit (such as 8-bit) activation values, providing strong support for reducing memory occupation of the model and improving the computational efficiency inside the model.

Moreover, due to the solution of the present disclosure is able to perform activation quantization processing on a feature block output by the first feed forward network on each GPU (such as “activation per tensor quantization”), the solution of the present disclosure can effectively improve the computing speed of the target expert module, providing strong support for achieving lossless quantization of the model. At this point, hardware that is compatible with the solution of the present disclosure also has strong versatility, laying a foundation for accelerating the inference speed of the model and improving the user experience in the future.

Furthermore, in a specific example, in order to effectively reduce pressure of activation quantization processing on the GPUs, improve processing efficiency of activation quantization processing, and avoid quantization loss, the solution of the present disclosure first migrates an outlier activation value in the feature block on each GPU to a single GPU, and then performs activation quantization processing on the feature block on each GPU, so that quantization loss is effectively avoided and activation quantization pressure on the GPUs is reduced. Specifically, in an example, it also includes:
determining at least one target GPU from the M GPUs.

At this point, performing activation quantization processing on the feature blocks to be input to the target feed forward network of the at least two feed forward networks as described above may specifically include:
migrating outlier activation values in feature blocks to be input into the target feed forward network in other GPUs to the target GPU, here, the other GPUs are GPUs except for the target GPU in the M GPUs.

Furthermore, after the migrating is completed, utilize each GPU to perform activation quantization processing on the feature blocks to be input into the target feed forward network.

Here, an outlier activation value in a feature block refer to an abnormal activation value that is significantly higher or lower than other activation values in the feature block. Furthermore, the abnormal activation value may lead to uneven distribution of data in the feature block.

It should be noted that the solution of the present disclosure does not limit a manner of determining the abnormal activation value and may be determined based on actual needs.

Here, it should be noted that migrating the outlier activation values in the feature blocks to be input into the target feed forward network from the other GPUs to the target GPU effectively reduces a number of outlier activation values in the feature blocks on the other GPUs. Meanwhile, data distribution of remaining activation values in the other GPUs becomes more uniform compared to before the migrating. Therefore, performing activation quantization processing may effectively avoid quantization loss, reduce quantization pressure, and improve quantization processing efficiency. For the target GPU, although it collects a large number of outlier activation values, data processing efficiency may decrease compared to before collecting, generally, it significantly improves overall processing efficiency and also significantly reduces overall quantization loss.

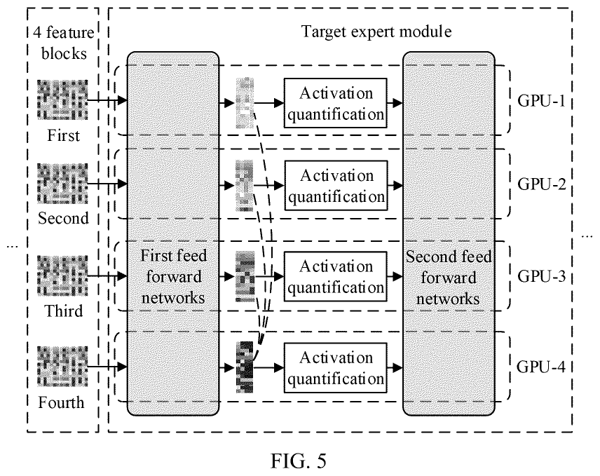

For example, taking four GPUs as an example, as shown in FIG. 5, with GPU-4 as the target GPU, an outlier activation value in a feature block to be input to the second feed forward network in GPU-1, an outlier activation value in a feature block to be input to the second feed forward network in GPU-2, and an outlier activation value in a feature block to be input to the second feed forward network in GPU-3 may all be migrated to the GPU-4 to form a new feature block in the GPU-4. Furthermore, after the migrating is completed, each GPU is utilized to perform activation quantization processing on the feature blocks to be input into the second feed forward network. This effectively improves activation quantization processing efficiency, laying the foundation for enhancing the inference efficiency of the model and improving the user experience.

It should be noted that the above example is based on the target feed forward network as the second feed forward network, and in practical applications, an outlier activation value in a feature block to be input to the first feed forward network in the GPU-1, an outlier activation value in a feature block to be input to the first feed forward network in the GPU-2, and an outlier activation value in a feature block to be input to the first feed forward network in the GPU-3 may all be migrated to the GPU-4 to form a new feature block in the GPU-4. Furthermore, after the migrating is completed, each GPU is utilized to perform activation quantization processing on the feature blocks to be input into the first feed forward network. This effectively improves the activation quantization processing efficiency, laying the foundation for enhancing the inference efficiency of the model and improving the user experience.

In this way, the solution of the present disclosure can relocate the outlier activation value in the feature block to be input to the target feed forward network in each of the M GPUs to a designated GPU in the M GPUs, which makes it easier to quantify feature blocks on other GPUs, effectively reducing activation quantization pressure on the other GPUs, and thus reducing overall activation quantization pressure, improving the activation quantization processing efficiency, and providing strong support for achieving efficient inference the model in the future.

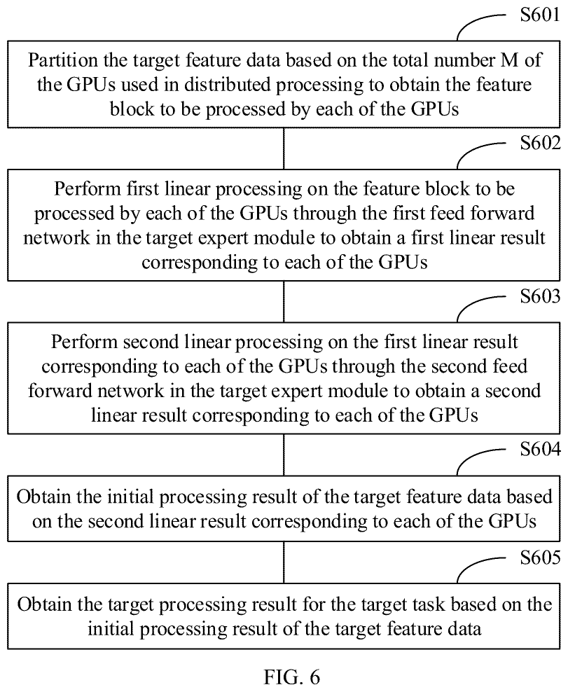

FIG. 6 is a second schematic flow diagram of a data processing method for an expert model according to an embodiment of the present disclosure. This method is optionally applied to an electronic device, such as a personal computer, a server, a server cluster or other electronic devices. It may be understood that the relevant contents of the methods shown in FIGS. 1 to 5 above may also be applied to this example, and the related contents will not be repeated in this example.

Furthermore, the method at least includes at least a portion of the following contents. As shown in FIG. 6, the method includes following steps.

In step S601, the target feature data is partitioned based on the total number M of the GPUs used in distributed processing to obtain the feature block to be processed by each of the GPUs, M is an integer greater than 1.

Here, the target feature data is the sub feature data in the total feature data corresponding to a target task.

In step S602, first linear processing is performed on the feature block to be processed each of the GPUs through the first feed forward network in the target expert module to obtain a first linear result corresponding to each of the GPUs.

In step S603, second linear processing is performed on the first linear result corresponding to each of the GPUs through the second feed forward network in the target expert module to obtain a second linear result corresponding to each of the GPUs.

Here weight channels targeted by the second linear processing are obtained by reordering all weight channels in the second feed forward network based on weight channels targeted by the first linear processing.

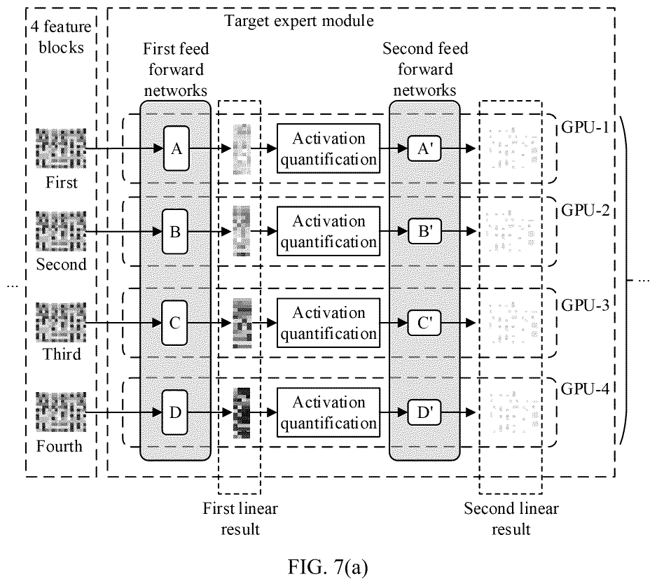

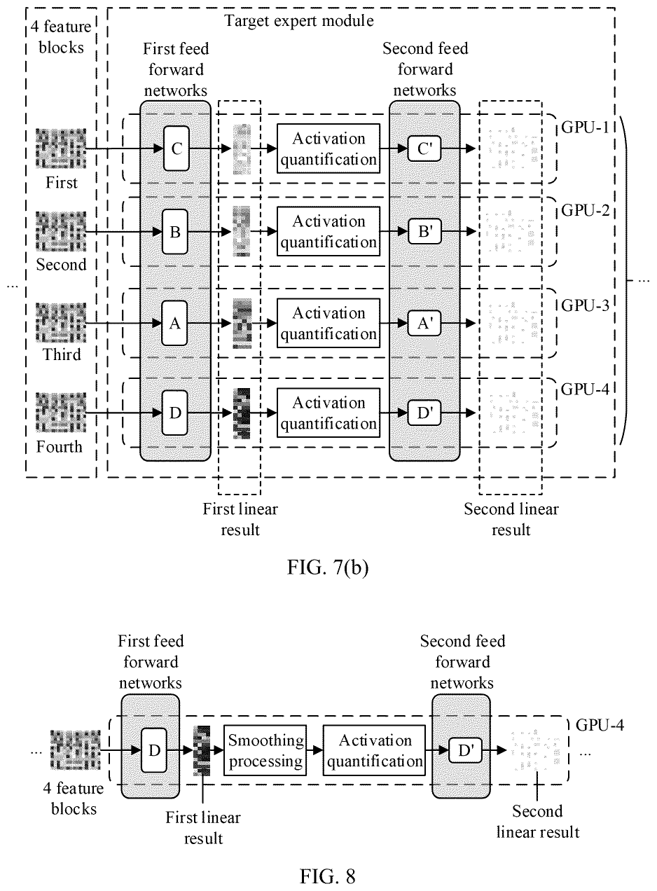

Here, it should be noted that, in practical applications, there is a corresponding relationship between weight channels in the second feed forward network and weight channels in the first feed forward network, in other words, there is a preset mapping relationship. For example, the preset mapping relationship is as follows: A-A′, B-B′, C-C′ and D-D′. Here, as shown in FIG. 7 (a), A, B, C and D represent the weight channels in the first feed forward network, and A′, B′, C′ and D′ represent the weight channels in the second feed forward network. At this point, it is necessary to reorder all the weight channels in the second feed forward network based on a channel order “A-B-C-D” of the weight channels targeted by the first linear processing, to obtain the ordered weight channels targeted by the second linear processing, such as obtaining ordered “A′-B′-C′-D′”. This ensures that a corresponding relationship between a weight channel of the first feed forward network and a second feed forward network on each GPU satisfies the preset mapping relationship described above, thereby enabling smooth data processing on each GPU.

In step S604, the initial processing result of the target feature data is obtained based on the second linear result corresponding to each of the GPUs.

In step S605, the target processing result for the target task is obtained based on the initial processing result of the target feature data.

In this way, when using the target expert module for data processing in the solution of the present disclosure, the M GPUs may be called to first perform the first linear processing on the M feature blocks corresponding to the target feature data to obtain respective first linear results, and then perform the second linear processing on the respective first linear results to obtain the initial processing result. In the above process, the weight channel targeted by the first linear processing on each GPU are obtained by reordering (such as first channel reordering or second channels reordering) all the weight channels in the first feed forward network, so that the data processing process on each GPU may proceed smoothly, laying the foundation for effectively improving the data processing efficiency, the inference effect, and the user experience of the target expert module in the future.

Furthermore, in an example, the weight channel targeted by the first linear processing on each GPU is obtained by performing the first channel reordering on all the weight channels in the first feed forward network. Here, an overlap degree between ranges of activation values in first linear results obtained from the first linear processing on different GPUs after performing the first channel reordering meets a preset requirement.

Here, the overlap degree between the ranges of the activation values in the first linear results obtained from the first linear processing on different GPUs may specifically refer to a length of an overlap range between value ranges of the activation values in different first linear results. Meanwhile, the greater the overlap degree, the higher the similarity between the ranges of the activation values in different first linear results, and otherwise, the smaller the overlap degree, the lower the similarity between the ranges of the activation values in different first linear results.

It should be noted that in order to make the range of the activation values in the first linear result corresponding to each GPU similar to each other, the solution of the present disclosure may first perform the first channel reordering on all the weight channels in the first feed forward network to obtain all the weight channels after performing the first channel reordering. Then, based on the number of the GPUs used in distributed processing, all the weight channels after performing the first channel reordering are partitioned, and then the partitioned weight channels are allocated to each GPU to obtain the weight channel targeted by the first linear processing on each GPU. In this way, it effectively ensures that the range of the activation values in the first linear result corresponding to each GPU is similar to each other, and further provides strong support for improving the activation quantization efficiency in the future.

Here, since the first channel reordering reorders all weight channels on all GPUs for being allocated to each GPU after reordering, the first channel reordering in this example may also be referred to as inter-card (i.e. inter-GPU) reordering.

Alternatively, in another example, the weight channel targeted by the first linear processing on each GPU is obtained by performing the second channel reordering on the weight channels which are subjected to the first channel reordering. Data distribution of activation values in first linear results obtained by being processed through the weight channels which are subjected to the second channel reordering is better than data distribution of activation values in first linear results obtained without the second channel reordering.

It should be noted that in order to make data distribution of the activation values in the first linear result corresponding to each GPU more uniform for subsequent smoothing processing, the solution of the present disclosure may further reorder the weight channel allocated to each GPU again after performing the first channel reordering, that is, performing the second channel reordering, to obtain the weight channel targeted by the first linear processing on each GPU. In this way, the data distribution of the activation values in the first linear result obtained by being processed using the weight channels which are subjected to the second channel reordering on each GPU is more uniform.

Here, since the second channel reordering is processing on the weight channel on each GPU, it can also be referred to as intra-card reordering.

It should be noted that, in practical applications, in a specific processing flow, the intra-card reordering described above may be selected for processing, or the inter-card reordering may be selected for processing, or both of which may be used, which is not limited by the solution of the present disclosure.

It should be noted that the channel reordering mentioned above in the solution of the present disclosure, such as the first channel reordering and the second channel reordering, are both offline processing, in other words, they are reordering completed before inference. In other words, offline reordering of the solution of the present disclosure can generate a quantization friendly model without affecting inference speed.

In this way, the solution of the present disclosure can reorder all the weight channels in the first feed forward network to make the range of the activation values in the first linear result obtained after the first linear processing on each GPU more similar to each other, thereby effectively reducing influence of the outlier activation values on data processing results, improving quantization efficiency and effectiveness, and laying the foundation for effectively improving the data processing efficiency, inference effect, and user experience of the target expert module in the future. Alternatively, the solution of the present disclosure may also perform the second channel reordering on the weight channel allocated to each GPU, so that the data distribution of the activation values in the first linear result obtained after the first linear processing on each GPU is more uniform. This lays the foundation for effectively improving the data processing efficiency, inference effect, and user experience of the target expert module in subsequent smoothing processing.

For example, as shown in FIG. 7 (b), before each GPU uses the target expert module for data processing, the channel reordering may be performed first. For example, the inter-card ordering is performed on the weight channels in the first feed forward network, and a reordered result is “C-B-A-D”. At this point, the weight channels targeted by the second linear processing in the second feed forward network (i.e. “A′-B′-C′-D′”) may be reordered by using the preset mapping relationship (such as A-A′, B-B′, C-C′ and D-D′) to obtain the weight channels targeted by the second linear processing on each GPU after the channel reordering, that is, “C′-B′-A′-D′”. In this way, the influence of the outlier activation values on the data processing results is effectively reduced, and quantization efficiency and effectiveness are improved.

Furthermore, in a specific example, the obtained second linear result may also be processed as follows to obtain the initial processing result. Specifically, obtaining the initial processing result of the target feature data based on the second linear result corresponding to each of the GPUs as described above (e.g., the step S604) may specifically include:
performing element level fusion processing on the second linear result corresponding to each of the GPUs to obtain the initial processing result of the target feature data.

It should be noted that after performing the second linear processing using the reordered weight channel on each GPU and obtaining the second linear result corresponding to each of the GPUs, the element level fusion processing may be performed on the second linear result corresponding to each of the GPUs to obtain the initial processing result.

Here, in an example, the element level fusion processing may specifically refer to as an all reduce operation, so that a plurality of data results may be summed up at an element level by using the all reduce operation, thereby effectively avoiding explicit reordering or misalignment. Furthermore, an aggregated result (i.e., the initial processing result) may be broadcasted to a next node for subsequent processing.

In this way, the solution of the present disclosure provides a refined solution for obtaining the initial processing result based on second linear results, which is simple and efficient, and provides strong support for obtaining an accurate model inference result in the future.

Furthermore, in a specific example, performing the second linear processing on the first linear result corresponding to each of the GPUs through the second feed forward network (e.g., the step S603) may specifically include:
performing smoothing processing on the first linear result corresponding to each of the GPUs, and performing the second linear processing through the second feed forward network after the smoothing processing.

For example, in an example, continuing with processing logic of the GPU-4 shown in FIG. 7(b) as an example, as shown in FIG. 8, after obtaining a first linear result corresponding to the GPU-4, the smoothing processing may be performed on the first linear result, and then the second linear processing is performed on the first linear result which is subjected to the smoothing processing, to obtain the second linear result corresponding to the GPU-4.

Furthermore, in an example, after obtaining the first linear result which is subjected to the smoothing processing, the activation quantization processing may further be performed on the first linear result which is subjected to the smoothing processing, so as to perform the second linear processing on the first linear result which is subjected to the activation quantization processing.

In this way, the solution of the present disclosure can effectively suppress noises (i.e., the outlier activation values) that may exist in the first linear result corresponding to each of the GPUs through the smoothing processing, making feature distribution of the first linear result which is subjected to the smoothing processing more uniform. This lays the foundation for effectively improving the data processing efficiency, the inference effect, and the user experience of the target expert module in the future.

Furthermore, in a specific example, the smoothing processing may be performed by using the following manner. Specifically, performing the smoothing processing on the first linear result corresponding to each of the GPUs above may specifically include:
determining a target smoothing manner based on distribution of the activation values in the first linear result corresponding to each of the GPUs, where the target smoothing manner is weight smoothing or activation smoothing; and
performing the smoothing processing on the first linear result corresponding to each of the GPUs by using the determined target smoothing manner.

That is, the solution of the present disclosure may determine a current appropriate smoothing manner from the weight smoothing and the activation smoothing based on the distribution of the activation values in the first linear result corresponding to the GPU, and perform the smoothing processing on the first linear result by using the determined smoothing manner. In other words, the solution of the present disclosure may determine, based on distribution of each layer of activation values in each GPU, whether the weight smoothing or the activation smoothing are preferentially used by the layer. In this way, while preserving key information, it may effectively reduce possible noise and enhance feature consistency, providing strong support for improving inference performance of the model.

Furthermore, in an example, determining the target smoothing manner based on the distribution of the activation values in the first linear result corresponding to each of the GPUs as described above specifically includes:
taking the weight smoothing as the target smoothing manner when the distribution of the activation values in the first linear result corresponding to the GPU satisfies a preset distribution requirement, or
taking the activation smoothing as the target smoothing manner when the distribution of the activation values in the first linear result corresponding to the GPU does not satisfy the preset distribution requirement.

That is, if the distribution of the activation values in the first linear result corresponding to the GPU satisfies the preset distribution requirement (for example, when the distribution of the activation values is relatively uniform), the weight smoothing is used to perform the smoothing processing on the first linear result, and otherwise, if the distribution of the activation values in the first linear result corresponding to the GPU does not satisfy the preset distribution requirement (such as when the distribution of the activation values is uneven), the activation smoothing is used to perform the smoothing processing the first linear result.

In this way, the solution of the present disclosure can quickly determine an appropriate smoothing manner based on the distribution of the activation values in the first linear result. Thus, while retaining the key information, it can effectively reduce the possible noise, making the first linear result which is subjected to the smoothing processing easier to activate quantization processing, improving the quantization efficiency, and laying the foundation for improving the inference efficiency of the model and enhancing the user experience in the future.

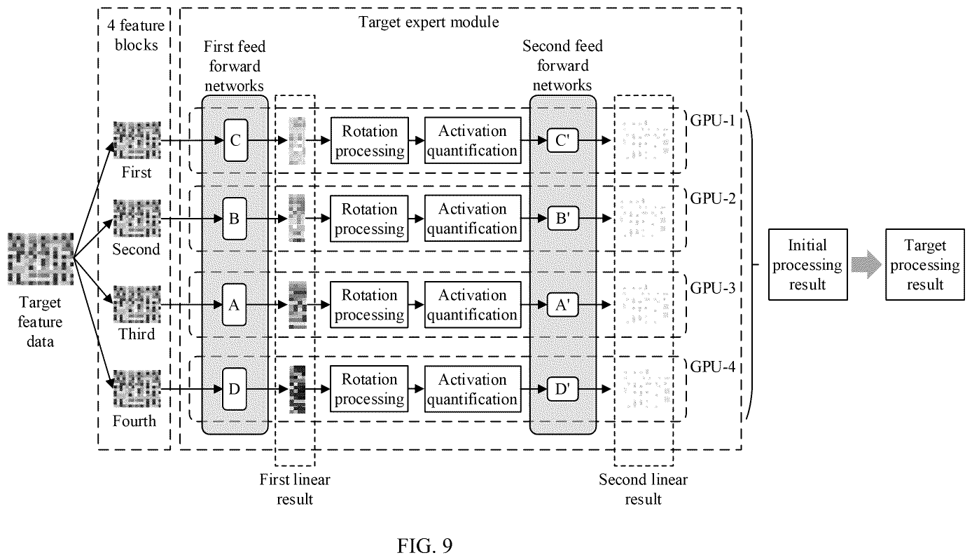

For example, taking the structure of the target expert module shown in FIG. 7 (b) as an example, as shown in FIG. 9, after obtaining the first linear result corresponding to each GPU, the target smoothing manner corresponding to each GPU is determined based on the distribution of the activation values in the first linear result corresponding to each GPU. Then, using the target smoothing manner corresponding to each GPU to perform the smoothing processing on the first linear result corresponding to each GPU, to obtain the first linear result which is subjected to the smoothing processing corresponding to each GPU. Then, the activation quantization processing is performed on the first linear result which is subjected to the smoothing processing corresponding to each GPU to obtain the first linear result which is subjected to the activation quantization processing corresponding to each GPU. At this point, the second linear processing is performed on the first linear result which is subjected to the activation quantization processing corresponding to each GPU through the second feed forward network to obtain the second linear result corresponding to each GPU, so as to finally obtain the initial processing result.

Here, in an example, block rotation processing (such as Hadamard transform, denoted as R4) may be used to performing the smoothing processing on abnormal value in the activation values or weight values, making the first linear result which is subjected to the rotation processing corresponding to each GPU easier for activation quantization (such as more suitable for int quantization). This effectively improves the activation quantization processing efficiency and provides strong support for improving the inference efficiency of the model in the future.

FIG. 10 is a third schematic flow diagram of a data processing method for an expert model according to an embodiment of the present disclosure. This method is optionally applied to an electronic device, such as a personal computer, a server, a server cluster or other electronic devices. It may be understood that the relevant contents of the methods shown in FIGS. 1 to 9 above may also be applied to this example, and the related contents will not be repeated in this example.

Furthermore, the method at least includes at least a portion of the following contents. As shown in FIG. 10, the method includes following steps.

In step S1001, the total feature data of the input target task is obtained based on an input module in the hybrid expert large model.

Here the hybrid expert large model (also known as a Mixture-of-Experts Large Language Model, MoE-LLM) includes a plurality of initial expert modules.

Here, it should be noted that, in an example, different initial expert modules are directed against different fields, but their network structures may be the same.

The solution of the present disclosure does not limit the fields targeted by the initial expert modules and specific network structures thereof.

In step S1002, at least one target expert module that matches field features of the target task and is used to process the total feature data is determined from the plurality of initial expert modules and the target feature data to be processed by the target expert module is determined, based on a gating module in the hybrid expert large module and based on the field features of the target task.

Here, the target feature data refers to the sub feature data in the total feature data corresponding to the target task.

That is, the solution of the present disclosure can utilize the gating module in the hybrid expert model and combine it with the field features of the target task to determine the at least one target expert module required for processing the target task from the plurality of initial expert modules included in the hybrid expert model and determine the target feature data to be processed by the target expert module from the total feature data of the target task.

In step S1003, with respect to each target expert module, the target feature data is partitioned based on the total number M (M is an integer greater than 1) of the GPUs used in distributed processing to obtain the feature block to be processed by each of the GPUs.

It should be noted that for the Mixture-of-Experts Large Language Model, considering their huge number of model parameters, each target expert module may be divided into models and deployed on a plurality of GPUs. In this way, the plurality of GPUs may be used to realize an inference process of each target expert module in parallel, which may also be referred to as model parallelism.

It should be noted that in a case where a plurality of target expert modules is required to process the target task, a number of GPUs called by different target expert modules for data processing may be the same or different. In other words, the value of M corresponding to different target expert modules may be the same or different.

In step S1004, the feature block to be processed by each of the GPUs is processed through the at least two feed forward networks in the target expert module to obtain the initial processing result of the target feature data.

In step S1005, the target processing result for the target task is obtained based on the initial processing result of the target feature data.

Here, in an example, in the case where the plurality of target expert modules is required to process the target task, an initial processing result may be obtained after each of target expert modules processes its corresponding target feature data, then the target processing result for the target task may be obtained based on the initial processing result of each target feature data.

In this way, when utilizing each target expert module in the hybrid expert large model for data processing, the solution of the present disclosure can call the plurality of GPUs to perform distributed processing on the plurality of feature blocks corresponding to respective target feature data. Consequently, when facing the task inference of the large-scale data, it can significantly improve the computational efficiency and the inference efficiency of the model while ensuring inference capability of the model, thereby ensuring real-time inference of the target expert module and laying the foundation for improving the user experience.

Moreover, as the solution of the present disclosure utilizes a dynamic routing mechanism (such as the gating module) to determine the at least one target expert module required for processing the target task, it significantly reduces computational cost (such as memory access cost) required for model processing, thereby reducing dependence on and occupation of a computational resource by the module, providing strong support for subsequent efficient deployment of the hybrid expert large model.

It should be noted that, during a quantization calibration process, there may be a caser where an expert module is not activated, at this point, the solution of the present disclosure may perform the activation quantization processing on the non-activated expert module (e.g., an initially unselected expert module) based on a collaborative strategy of expert modules. For instance, based on quantization results of activation values of the target expert module in the same layer, quantization results of the corresponding layer of the non-activated expert module are obtained. For example, in an example, an average value of quantization results of activation values of another activated expert module (i.e., the target expert module) in the same layer may be used as the quantization results of the non-activated expert module. In this way, when subsequently invoking another expert module to process a task, a calibration process of quantization parameters can be effectively shortened, thereby improving processing efficiency.

### Second Part, Weight Quantification

Specifically, at least a part of the following processing manners may be used to quantify weight parameters in the target expert module.

It should be noted that due to a fact that the hybrid expert large model often has thousands of linear layers, when quantifying weights, if one linear layer after another is optimized through quantization, sufficient data is needed to activate all expert modules during the calibration process, which reduces efficiency. Based on this, the solution of the present disclosure provides a method for parallel calibration and optimization of an expert module, which may only use a prefill process for calibration. In this way, a sufficient number of expert modules may be efficiently activated, providing strong support for improving the inference efficiency of the hybrid expert large model (such as for performing the large-scale data inference) in the future.

Specifically, in an example, the following manner may be used to perform the weight quantification and specifically include the following step.

Weight parameters in feed forward networks at a same level in different target expert modules may further be concatenated before performing the linear processing through the feed forward networks in the target expert module, to perform weight quantization processing (such as per-channel quantization) on the concatenated weight parameters, so as to processing the input feature blocks by using the feed forward networks which are subjected to the weight quantization after performing the weight quantization processing.

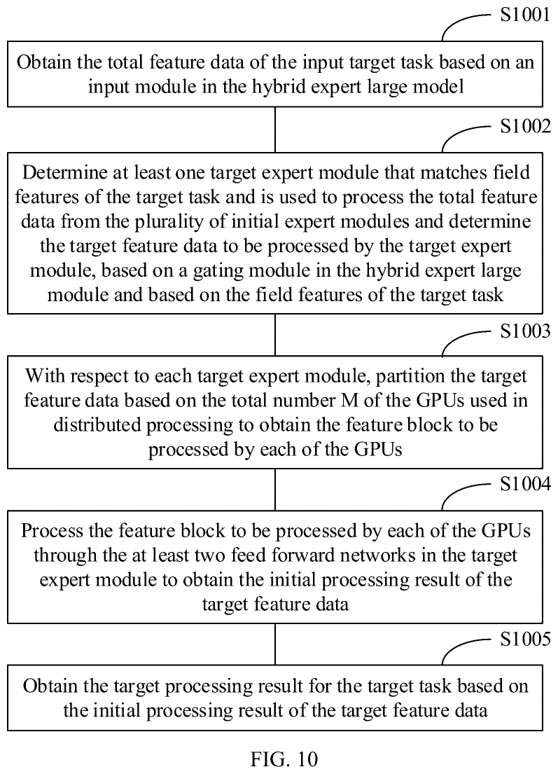

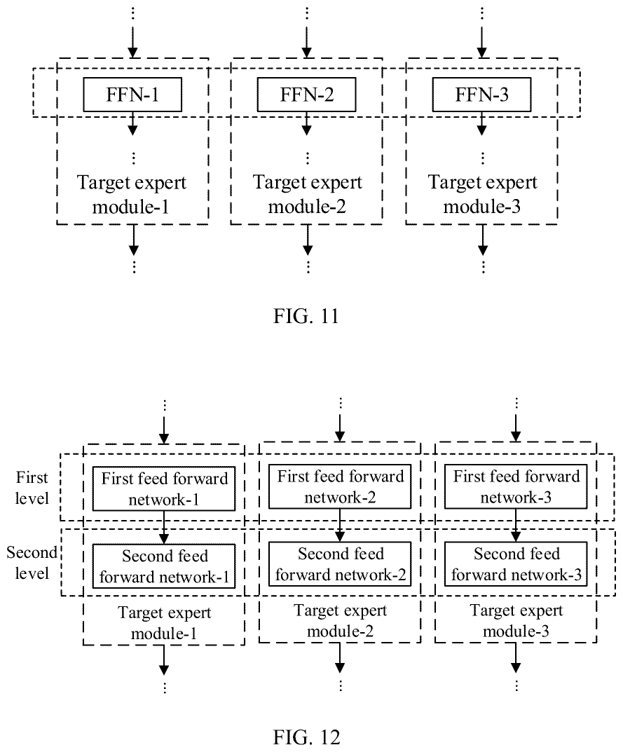

For example, in an example where processing the target task requires use of three target expert modules, as shown in FIG. 11, before the weight quantization, weight parameters of the feed forward networks at the same level, namely, a feed forward network-1 (denoted as FNN-1) in a target expert module-1, a feed forward network-2 (denoted as FNN-2) in a target expert module-2, and a feed forward network-3 (denoted as FNN-3) in a target expert module-3, are concatenated, and the concatenated weight parameters are then subjected to the weight quantization processing. For example, weight parameters represented by high-bit (such as 32-bit or 16-bit) are quantized into weight parameters represented by low-bit (such as 4-bit). In this way, compared to directly using the weight parameters of the high-bit, the solution of the present disclosure effectively reduces dependence on and occupation of a hardware resource by the module, thereby achieving quantitative compression of the target expert module.

Furthermore, in an example, above processing through the at least two feed forward networks in the target expert module (for example, the step S1004) specifically includes:
processing thought at least two feed forward networks which are subjected to the weight quantization processing in the target expert module.

That is, the solution of the present disclosure can concatenate the weight parameters of all expert modules belonging to the same layer together. At this point, their calibration datasets may be used for batch updating (for example, using a parallel computing feature of the GPU for batch updating). Compared to updating a linear layer of an expert module each time, the solution of the present disclosure may batch update all linear layers in a layer of expert modules, thereby effectively improving quantization processing efficiency.

It should be noted that a process of batch updating all linear layers in a layer of the expert modules in the solution of the present disclosure may be referred to as Generative Pre trained Transformer Quantization (GPTQ) for batch.

In this way, the solution of the present disclosure can concatenate the weight parameters of the feed forward networks at the same level in different target expert modules, and then quantize the concatenated weight parameters, so that the target expert module can use the at least two feed forward networks which are subjected to the weight quantization processing for data processing. This effectively improves the processing efficiency of the target expert module. For example, by using the weight quantization processing, the weight parameters represented by high-bit can be quantized into the weight parameters represented by low-bit. This achieves quantization compression of the target expert module, thereby ensuring the inference capability of the model while significantly reducing dependence on and occupation of a hardware resource (such as a computing resource, a storage space, or the like) by the model, and laying the foundation for improving the inference efficiency of the model and enhancing the user experience.

Moreover, the weight quantization manner of the solution of the present disclosure can reduce data bit widths of the weight parameters in the hybrid expert large model while ensuring accuracy of the model without loss, thus providing strong support for achieving low-cost and efficient deployment of the hybrid expert large models.

Furthermore, in a specific example, each target expert module includes a first feed forward network and a second feed forward network. At this point, first feed forward networks in different target expert modules may be considered to be at the same level, and similarly, second feed forward networks in different target expert modules may also be considered to be at the same level.

For example, again in the example where processing the target task requires the use of three target expert modules, as shown in FIG. 12, each target expert module (such as the target expert module-1, the target expert module-2, and the target expert module-3) includes a first feed forward network and a second feed forward network. The respective first feed forward networks (i.e., the first feed forward network-1, the first feed forward network-2, and the first feed forward network-3) in the respective target expert module are at the first level, and similarly, the second feedforward network (i.e., the second feed forward network-1, the second feed forward network-2, and the second feed forward network-3) in the respective target expert modules are at the second level.

At this point, the following manner may be used to perform the weight quantization processing on weight parameters of the first feed forward networks in different target expert modules. Specifically, the above concatenating the weight parameters of the feed forward networks at the same level in different target expert modules to perform the weight quantization process on the concatenated weight parameters may specifically include:
concatenating the weight parameters of the first feed forward networks in different target expert modules to perform the weight quantization processing on the concatenated weight parameters.

For example, as shown in FIG. 12, weight parameters in the first feed forward network-1, weight parameters in the first feed forward network-2 and weight parameters in the first feed forward network-3 are concatenated to perform the weight quantization processing on the concatenated weight parameters. In this way, quantization efficiency of the weight parameters of the first feed forward networks in the respective target expert modules is effectively improved, thereby providing strong support for enhancing the inference efficiency of the model.

Furthermore, in a specific example, the above concatenating the weight parameters of the first feed forward networks in different target expert modules to perform the weight quantization processing on the concatenated weight parameters may specifically include:
concatenating the weight parameters of the first feed forward networks in different target expert modules to perform the weight quantization processing on weight parameters in a hotspot expert module of the concatenated weight parameters.

Here, the hotspot expert module is a target expert module whose frequency of activating a token is higher than a preset value of the at least one target expert module.

That is, based on the frequency of activating the token in target expert modules required for processing the target task, at least one target expert module whose frequency of activating the token is higher than the preset value is determined from the required target expert modules, and then the selected target expert module is used as the hotspot expert module. Furthermore, after concatenating the weight parameters of the first feed forward network in different target expert modules, batch quantization is performed on weight parameters in all hotspot expert modules in the concatenated weight parameters. In this way, the quantification efficiency of weight parameters in the target expert module has been effectively improved.

In this way, when quantifying the weight parameters of the first feed forward network in different target expert modules, the solution of the present can perform the batch quantization on the weight parameters belonging to the hotspot expert module in the concatenated weight parameters (also known as “hotspot batch quantization”), effectively improving the quantization efficiency of the weight parameters, and reducing occupation of a hardware resource (such as a video memory resource) during the weight quantization processing (such as reducing video memory overhead), thereby achieving quantization compression of each target expert module, laying the foundation for improving the inference efficiency of the model and enhancing the user experience.

In another specific example, the following manner may be used to perform the weight quantization on the weight parameters of the second feed forward network in different target expert modules. Specifically, the above concatenating the weight parameters of the feed forward networks at the same level in different target expert modules to perform the weight quantization processing on the concatenated weight parameters may also specifically include:
concatenating the weight parameters of second feed forward networks in different target expert modules to perform the weight quantization processing on the concatenated weight parameters.

For example, in an example, as shown in FIG. 12, weight parameters of the second feed forward network-1, weight parameters of the second feed forward network-2, and weight parameters of the second feedforward network-3 are concatenated to perform the weight quantization processing on the concatenated weight parameters. In this way, quantization efficiency of the weight parameters of the second feed forward networks in the respective target expert modules is effectively improved, thereby providing strong support for enhancing the inference efficiency of the model.

Furthermore, in a specific example, the above concatenating the weight parameters of the second feed forward networks in different target expert modules to perform the weight quantization processing on the concatenated weight parameters specifically includes:
concatenating the weight parameters of the second feed forward networks in different target expert modules to perform the weight quantization processing on weight parameters in the hotspot expert module of the concatenated weight parameters.

Here, the hotspot expert module is the target expert module whose frequency of activating the token is higher than the pre-set value of the at least one target expert module.

In this way, when quantifying the weight parameters of the second feed forward network in different target expert modules, the solution of the present can perform the batch quantization on the weight parameters belonging to the hotspot expert module in the concatenated weight parameters (also known as “hotspot batch quantization”), in this way, the quantization efficiency of the weight parameters is effectively improved, and the occupation of the hardware resource (such as a video memory resource) during the weight quantization processing (such as reducing video memory overhead) is reduced, thereby achieving the quantization compression of each target expert module, laying the foundation for improving the inference efficiency of the model and enhancing the user experience.

It should be noted that, in practical applications, the solution of the present disclosure may also perform the hotspot batch quantization on the weight parameters of the first feed forward network at the same level in different target expert modules, and perform conventional batch quantization on the weight parameters of the second feed forward network at the same level (i.e., quantify all the concatenated weight parameters, rather than just the hotspot expert modules), alternatively, perform the conventional batch quantization on the weight parameters of the first feed forward network at the same level in different target expert modules, and perform the hotspot batch quantization on the weight parameters of the second feed forward network at the same level, alternatively, perform the hotspot batch quantization on the weight parameters of the first feed forward network at the same level and the weight parameters of the second feed forward network at the same level in different target expert modules. In practical applications, it may be determined based on actual needs, and are not limited in the solution of the present disclosure.

The solution of the present disclosure provides a static statistical quantization solution without introducing any dynamic calculation of a scale in an inference stage, thereby avoiding degradation of inference performance. Moreover, quantization granularity at a weight end of the solution of the present disclosure is per-channel quantization granularity, and a number of quantization bits may be 4-bit, and quantization at an activation end is per-tensor quantization granularity, and a number of quantization bits may be 8-bit. Therefore, the solution of the present disclosure can significantly accelerate a calculation process of an expert part (MoE) in the hybrid expert large model.

In addition, a quantitative inference technology of the solution of the present disclosure can significantly reduce computational overhead of the expert part in inference calculation of the hybrid expert large language model, thereby greatly improving smoothness and satisfaction of a user during an application usage process. At this point, the solution has successfully reduced dependence on and occupation of a hardware resource (such as a computing capability, a storage space, or the like) while ensuring performance of the model, providing strong support for rational allocation and efficient utilization of resources, and further promoting popularization and deepening of artificial intelligence technology in various application scenarios.

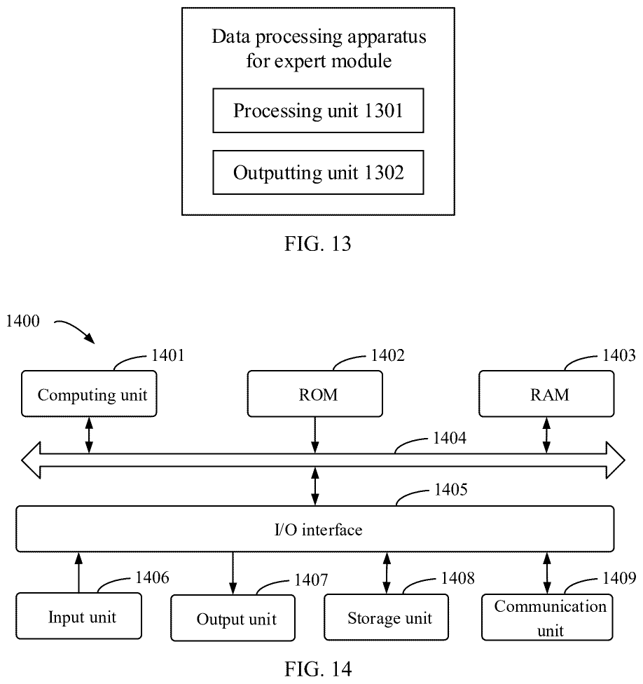

The solution of the present disclosure further provides a data processing apparatus for an expert model, as shown in FIG. 13, which includes following units.

A processing unit 1301 is configured to partition target feature data based on a total number M of GPUs used in distributed processing to obtain a feature block to be processed by each of the GPUs, process the feature block to be processed by each of the GPUs through at least two feed forward networks in a target expert module to obtain an initial processing result of the target feature data, and obtain a target processing result for the target task based on the initial processing result of the target feature data, where the target feature data is sub feature data in total feature data corresponding to a target task, M is an integer greater than 1.

An outputting unit 1302 is configured to output the target processing result for the target task.

In a specific example of the solution of the present disclosure, the processing unit is further configured to:
perform activation quantization processing on feature blocks to be input into a target feed forward network of the at least two feed forward networks before processing through the feed forward networks, and process through the feed forward networks after the activation quantization processing is completed, to obtain the initial processing result of the target feature data.

In a specific example of the solution of the present disclosure, the at least two feed forward networks include a first feed forward network and a second feed forward network connected in series with the first feed forward network, and
where the target feed forward network is the first feed forward network or the second feed forward network.

In a specific example of the solution of the present disclosure, the processing unit is further configured to:
determine at least one target GPU from M GPUs,
migrate outlier activation values in feature blocks to be input into the target feed forward network in other GPUs to the target GPU, where the other GPUs are GPUs except for the target GPU in the M GPUs; and
perform the activation quantization processing on the feature blocks to be input into the target feed forward network by using each of the GPUs, after the migrating is completed.

In a specific example of the solution of the present disclosure, the processing unit is specifically configured to:
perform first linear processing on the feature block to be processed by each of the GPUs through the first feed forward network to obtain a first linear result corresponding to each of the GPUs;
perform second linear processing on the first linear result corresponding to each of the GPUs through the second feed forward network to obtain a second linear result corresponding to each of the GPUs, where weight channels targeted by the second linear processing are obtained by reordering all weight channels in the second feed forward network based on weight channels targeted by the first linear processing; and
obtain the initial processing result of the target feature data based on the second linear result corresponding to each of the GPUs.

In a specific example of the solution of the present disclosure, a weight channel targeted by the first linear processing on each of the GPUs is obtained by performing first channel reordering on all weight channels in the first feed forward network, where an overlap degree of ranges of activation values in first linear results obtained from the first linear processing on different GPUs after performing the first channel reordering meets a preset requirement; and/or
the weight channel target by the first linear processing on each of the GPUs is obtained by performing second channel ordering on the weight channels which have subjected to the first channel reordering, wherein data distribution of activation values in first linear results obtained by being processed through the weight channels which are subjected to the second channel reordering is better than data distribution of activation values in first linear results obtained without the second channel reordering.

In a specific example of the solution of the present disclosure, the processing unit is specifically configured to:
perform element level fusion processing on the second linear result corresponding to each of the GPUs to obtain the initial processing result of the target feature data.

In a specific example of the solution of the present disclosure, the processing unit is specifically configured to:
perform smoothing processing on the first linear result corresponding to each of the GPUs, and perform the second linear processing through the second feed forward network after the smoothing processing.

In a specific example of the solution of the present disclosure, the processing unit is specifically configured to:
determine a target smoothing manner based on distribution of activation values in the first linear result corresponding to each of the GPUs, wherein the target smoothing manner is weight smoothing or activation smoothing; and
perform the smoothing processing on the first linear result corresponding to each of the GPUs by using the determined target smoothing manner.

In a specific example of the solution of the present disclosure, the processing unit is specifically configured to:
take the weight smoothing as the target smoothing manner when the distribution of the activation values in the first linear result corresponding to the GPU satisfies a preset distribution requirement, or
take the activation smoothing as the target smoothing manner when the distribution of the activation values in the first linear result corresponding to the GPU does not satisfy the preset distribution requirement.

In a specific example of the solution of the present disclosure, the processing unit is further configured to:
obtain the total feature data of the input target task based on an input module in a hybrid expert large model, the hybrid expert large model comprises a plurality of initial expert modules; and
determine at least one target expert module that matches field features of the target task and is used to process the total feature data from the plurality of initial expert modules and determine the target feature data to be processed by the target expert module, based on a gating module in the hybrid expert large module and based on the field features of the target task.

In a specific example of the solution of the present disclosure, the processing unit is further configured to:
concatenate weight parameters in feed forward networks at a same level in different target expert modules, to perform weight quantization processing on the concatenated weight parameters; and
process at least thought at least two feed forward networks which are subjected to the weight quantization processing in the target expert module.

In a specific example of the solution of the present disclosure, the processing unit is specifically configured to:
concatenate weight parameters of first feed forward networks in different target expert modules to perform the weight quantization processing on the concatenated weight parameters.

In a specific example of the solution of the present disclosure, the processing unit is specifically configured to:
concatenate the weight parameters of the first feed forward networks in different target expert modules to perform the weight quantization processing on weight parameters in a hotspot expert module of the concatenated weight parameters,
where the hotspot expert module is a target expert module whose frequency of activating a token is higher than a preset value of the at least one target expert module.

In a specific example of the solution of the present disclosure, the processing unit is specifically configured to:
concatenate weight parameters of second feed forward networks in different target expert modules to perform the weight quantization processing on the concatenated weight parameters.

In a specific example of the solution of the present disclosure, the processing unit is specifically configured to:
concatenating the weight parameters of the second feed forward networks in different target expert modules to perform the weight quantization processing on weight parameters in a hotspot expert module of the concatenated weight parameters,
where the hotspot expert module is a target expert module whose frequency of activating a token is higher than a preset value of the at least one target expert module.

Descriptions to specific functions and examples of respective units in the apparatus according to the embodiment of the present disclosure may refer to related descriptions to corresponding steps of the above method embodiments, and will not be repeated here.

In the technical solution of the present disclosure, acquisition, storage and application of a user's personal information involved are all in compliance with provisions of relevant laws and regulations, and do not violate public order and good customs.

According to an embodiment of the present disclosure, the present disclosure further provides an electronic device, a readable storage medium and a computer program product.

FIG. 14 shows a schematic block diagram of an exemplary electronic device 1400 that may be used to implement the embodiments of the present disclosure. The electronic device is intended to represent various forms of digital computers, such as a laptop, a desktop, a workstation, a personal digital assistant, a server, a blade server, a mainframe computer, and other suitable computers. The electronic device may also represent various forms of mobile devices, such as a personal digital processing, a cellular phone, a smart phone, a wearable device and other similar computing devices. The components shown herein, their connections and relationships, and their functions are merely examples, and are not intended to limit the implementation of the present disclosure described and/or required herein.

As shown in FIG. 14, the device 1400 includes a computing unit 1401 that may perform various appropriate actions and processes according to a computer program stored in a Read-Only Memory (ROM) 1402 or a computer program loaded from a storage unit 1408 into a Random Access Memory (RAM) 1403. Various programs and data required for operations of the device 1400 may also be stored in the RAM 1403. The computing unit 1401, the ROM 1402 and the RAM 1403 are connected to each other through a bus 1404. An input/output (I/O) interface 1405 is also connected to the bus 1404.

A plurality of components in the device 1400 are connected to the I/O interface 1405, and include an input unit 1406 such as a keyboard, a mouse, or the like; an output unit 1407 such as various types of displays, speakers, or the like; the storage unit 1408 such as a magnetic disk, an optical disk, or the like; and a communication unit 1409 such as a network card, a modem, a wireless communication transceiver, or the like. The communication unit 1409 allows the device 1400 to exchange information/data with other devices through a computer network such as the Internet and/or various telecommunication networks.

The computing unit 1401 may be various general-purpose and/or special-purpose processing components with processing and computing capabilities. Some examples of the computing unit 1401 include, but are not limited to, a Central Processing Unit (CPU), a Graphics Processing Unit (GPU), various dedicated Artificial Intelligence (AI) computing chips, various computing units that run machine learning model algorithms, a Digital Signal Processor (DSP), and any appropriate processors, controllers, microcontrollers, or the like. The computing unit 1401 performs various methods and processing described above, such as the data processing method for the expert model. For example, in some implementation, the data processing method for the expert model may be implemented as a computer software program tangibly contained in a computer-readable medium, such as the storage unit 1408. In some implementations, a part or all of the computer program may be loaded and/or installed on the device 1400 via the ROM 1402 and/or the communication unit 1409. When the computer program is loaded into RAM 1403 and executed by the computing unit 1401, one or more steps of the data processing method for the expert model described above may be performed. Alternatively, in other embodiments, the computing unit 1401 may be configured to perform the data processing method for the expert model by any other suitable means (e.g., by means of firmware).

Various implements of the system and technologies described above herein may be implemented in a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, firmware, software, and/or a combination thereof. These various implementations may include being implemented in one or more computer programs, and the one or more computer programs may be executed and/or interpreted on a programmable system including at least one programmable processor. The programmable processor may be a special-purpose or general-purpose programmable processor, may receive data and instructions from a storage system, at least one input device, and at least one output device, and transmit the data and the instructions to the storage system, the at least one input device, and the at least one output device.

Program codes for implementing the method of the present disclosure may be written in any combination of one or more programming languages. The program codes may be provided to a processor or controller of a general-purpose computer, a special-purpose computer or other programmable data processing devices, which enables the program codes, when executed by the processor or controller, to cause the functions/operations specified in the flow diagram and/or block diagram to be implemented. The program codes may be completely executed on a machine, partially executed on the machine, partially executed on the machine as a separate software package and partially executed on a remote machine, or completely executed on the remote machine or a server.

In the context of the present disclosure, a machine-readable medium may be a tangible medium, which may contain or store a procedure for use by or in connection with an instruction execution system, device or apparatus. The machine-readable medium may be a machine-readable signal medium or a machine-readable storage medium. The machine-readable medium may include, but is not limited to, an electronic, magnetic, optical, electromagnetic, infrared or semiconductor system, device or apparatus, or any suitable combination thereof. More specific examples of the machine-readable storage medium may include electrical connections based on one or more lines, a portable computer disk, a hard disk, a Random Access Memory (RAM), a Read-Only Memory (ROM), an Erasable Programmable Read-Only Memory (EPROM or a flash memory), an optical fiber, a portable Compact Disc Read-Only Memory (CD-ROM), an optical storage device, a magnetic storage device, or any suitable combination thereof.

In order to provide interaction with a user, the system and technologies described herein may be implemented on a computer that has: a display apparatus (e.g., a cathode ray tube (CRT) or a Liquid Crystal Display (LCD) monitor) for displaying information to a user; and a keyboard and a pointing device (e.g., a mouse or a trackball) through which the user may provide input to the computer. Other types of apparatuses may also be used to provide interaction with the user. For example, feedback provided to the user may be any form of sensory feedback (e.g., visual feedback, auditory feedback, or tactile feedback), and the input from the user may be received in any form (including an acoustic input, a voice input, or a tactile input).

The system and technologies described herein may be implemented in a computing system including a back-end component (which serves as, for example, a data server), or in a computing system including a middleware component (which serves as, for example, an application server), or in a computing system including a front-end component (e.g., a user computer with a graphical user interface or a web browser through which the user may interact with the implementation of the system and technologies described herein), or in a computing system including any combination of the back-end component, the middleware component, or the front-end component. Components of the system may be connected to each other through digital data communication in any form or medium (e.g., a communication network). Examples of the communication network include a Local Area Network (LAN), a Wide Area Network (WAN), and the Internet.

A computer system may include a client and a server. The client and the server are generally far away from each other and usually interact with each other through the communication network. A relationship between the client and the server is generated by computer programs running on corresponding computers and having a client-server relationship with each other. The server may be a cloud server, a distributed system server, or a blockchain server.

It should be understood that, steps may be reordered, added or removed by using various forms of the flows described above. For example, respective steps recorded in the present disclosure may be performed in parallel, in sequence, or in different orders, as long as a desired result of the technical solution disclosed in the present disclosure can be realized, which is not limited herein.

The foregoing specific implementations do not constitute a limitation on the protection scope of the present disclosure. Those having skill in the art should understand that, various modifications, combinations, sub-combinations and substitutions may be made according to a design requirement and other factors. Any modification, equivalent replacement, improvement or the like made within the principle of the present disclosure shall be included in the protection scope of the present disclosure.

What is claimed is:

1. A data processing method for an expert model, comprising:
partitioning target feature data based on a total number M of GPUs used in distributed processing to obtain a feature block to be processed by each of the GPUs, wherein the target feature data is sub feature data in total feature data corresponding to a target task, M is an integer greater than 1;
processing the feature block to be processed by each of the GPUs through at least two feed forward networks in a target expert module to obtain an initial processing result of the target feature data; and
obtaining a target processing result for the target task based on the initial processing result of the target feature data.

2. The method of claim 1, further comprising:
performing activation quantization processing on feature blocks to be input into a target feed forward network of the at least two feed forward networks before processing through the feed forward networks, and processing through the feed forward networks after the activation quantization processing is completed, to obtain the initial processing result of the target feature data.

3. The method of claim 2, wherein the at least two feed forward networks comprise a first feed forward network and a second feed forward network connected in series with the first feed forward network, and
wherein the target feed forward network is the first feed forward network or the second feed forward network.

4. The method of claim 2, further comprising:
determining at least one target GPU from M GPUs,
wherein the performing of the activation quantization processing on the feature blocks to be input into the target feed forward network of the at least two feed forward networks, comprises:
migrating outlier activation values in feature blocks to be input into the target feed forward network in other GPUs to the target GPU, wherein the other GPUs are GPUs except for the target GPU in the M GPUs; and
performing the activation quantization processing on the feature blocks to be input into the target feed forward network by using each of the GPUs, after the migrating is completed.

5. The method of claim 3, wherein the processing of the feature block to be processed by each of the GPUs through the at least two feed forward networks in the target expert module to obtain the initial processing result of the target feature data, comprises:
performing first linear processing on the feature block to be processed by each of the GPUs through the first feed forward network to obtain a first linear result corresponding to each of the GPUs;
performing second linear processing on the first linear result corresponding to each of the GPUs through the second feed forward network to obtain a second linear result corresponding to each of the GPUs, wherein weight channels targeted by the second linear processing are obtained by reordering all weight channels in the second feed forward network based on weight channels targeted by the first linear processing; and
obtaining the initial processing result of the target feature data based on the second linear result corresponding to each of the GPUs.

6. The method of claim 5, wherein a weight channel targeted by the first linear processing on each of the GPUs is obtained by performing first channel reordering on all weight channels in the first feed forward network, wherein an overlap degree of ranges of activation values in first linear results obtained from the first linear processing on different GPUs after performing the first channel reordering meets a preset requirement, and/or
the weight channel target by the first linear processing on each of the GPUs is obtained by performing second channel ordering on the weight channels which have subjected to the first channel reordering, wherein data distribution of activation values in first linear results obtained by being processed through the weight channels which are subjected to the second channel reordering is better than data distribution of activation values in first linear results obtained without the second channel reordering.

7. The method of claim 5, wherein the obtaining of the initial processing result of the target feature data based on the second linear result corresponding to each of the GPUs, comprises:
performing element level fusion processing on the second linear result corresponding to each of the GPUs to obtain the initial processing result of the target feature data.

8. The method of claim 5, wherein the performing of the second linear processing on the first linear result corresponding to each of the GPUs through the second feed forward network, comprises:
performing smoothing processing on the first linear result corresponding to each of the GPUs, and performing the second linear processing through the second feed forward network after the smoothing processing.

9. The method of claim 8, wherein the performing of the smoothing processing on the first linear result corresponding to each of the GPUs, comprises:
determining a target smoothing manner based on distribution of activation values in the first linear result corresponding to each of the GPUs, wherein the target smoothing manner is weight smoothing or activation smoothing; and
performing the smoothing processing on the first linear result corresponding to each of the GPUs by using the determined target smoothing manner.

10. The method of claim 9, wherein the determining of the target smoothing manner based on the distribution of the activation values in the first linear result corresponding to each of the GPUs, comprises:
taking the weight smoothing as the target smoothing manner, in a case where the distribution of the activation values in the first linear result corresponding to the GPU satisfies a preset distribution requirement, or
taking the activation smoothing as the target smoothing manner, in a case where the distribution of the activation values in the first linear result corresponding to the GPU does not satisfy the preset distribution requirement.

11. The method of claim 3, further comprising:
obtaining the total feature data of the input target task based on an input module in a hybrid expert large model, the hybrid expert large model comprises a plurality of initial expert modules; and
determining at least one target expert module that matches field features of the target task and is used to process the total feature data from the plurality of initial expert modules and determining the target feature data to be processed by the target expert module, based on a gating module in the hybrid expert large module and based on the field features of the target task.

12. The method of claim 11, further comprising:
concatenating weight parameters in feed forward networks at a same level in different target expert modules, to perform weight quantization processing on the concatenated weight parameters,
wherein processing through the at least two feed forward networks in the target expert module, comprises:
processing at least thought at least two feed forward networks which are subjected to the weight quantization processing in the target expert module.

13. The method of claim 12, wherein the concatenating of the weight parameters of the feed forward networks at the same level in different target expert modules to perform the weight quantization processing on the concatenated weight parameters, comprises:
concatenating weight parameters of first feed forward networks in different target expert modules to perform the weight quantization processing on the concatenated weight parameters.

14. The method of claim 13, wherein the concatenating of the weight parameters of the first feed forward networks in different target expert modules to perform the weight quantization processing on the concatenated weight parameters, comprises:
concatenating the weight parameters of the first feed forward networks in different target expert modules to perform the weight quantization processing on weight parameters in a hotspot expert module of the concatenated weight parameters, and
wherein the hotspot expert module is a target expert module whose frequency of activating a token is higher than a preset value of the at least one target expert module.

15. The method of claim 12, wherein the concatenating of the weight parameters of the feed forward networks at the same level in different target expert modules to perform the weight quantization processing on the concatenated weight parameters, comprises:
concatenating weight parameters of second feed forward networks in different target expert modules to perform the weight quantization processing on the concatenated weight parameters.

16. The method of claim 15, wherein the concatenating of the weight parameters of the second feed forward networks in different target expert modules to perform the weight quantization processing on the concatenated weight parameters, comprises:
concatenating the weight parameters of the second feed forward networks in different target expert modules to perform the weight quantization processing on weight parameters in a hotspot expert module of the concatenated weight parameters, and
wherein the hotspot expert module is a target expert module whose frequency of activating a token is higher than a preset value of the at least one target expert module.

17. An electronic device, comprising:
at least one processor; and
a memory connected in communication with the at least one processor,
wherein the memory stores an instruction executable by the at least one processor, and the instruction, when executed by the at least one processor, enables the at least one processor to execute:
partitioning target feature data based on a total number M of GPUs used in distributed processing to obtain a feature block to be processed by each of the GPUs, wherein the target feature data is sub feature data in total feature data corresponding to a target task, M is an integer greater than 1;
processing the feature block to be processed by each of the GPUs through at least two feed forward networks in a target expert module to obtain an initial processing result of the target feature data; and
obtaining a target processing result for the target task based on the initial processing result of the target feature data.

18. The electronic device of claim 17, wherein the instruction, when executed by the at least one processor, enables the at least one processor to further execute:
performing activation quantization processing on feature blocks to be input into a target feed forward network of the at least two feed forward networks before processing through the feed forward networks, and processing through the feed forward networks after the activation quantization processing is completed, to obtain the initial processing result of the target feature data.

19. A non-transitory computer-readable storage medium storing a computer instruction thereon, wherein the computer instruction is used to cause a computer to execute:
partitioning target feature data based on a total number M of GPUs used in distributed processing to obtain a feature block to be processed by each of the GPUs, wherein the target feature data is sub feature data in total feature data corresponding to a target task, M is an integer greater than 1;
processing the feature block to be processed by each of the GPUs through at least two feed forward networks in a target expert module to obtain an initial processing result of the target feature data; and
obtaining a target processing result for the target task based on the initial processing result of the target feature data.

20. The non-transitory computer-readable storage medium of claim 19, wherein the computer instruction is used to cause the computer to further execute:
performing activation quantization processing on feature blocks to be input into a target feed forward network of the at least two feed forward networks before processing through the feed forward networks, and processing through the feed forward networks after the activation quantization processing is completed, to obtain the initial processing result of the target feature data.
